(19) United States
(12) Patent Application Publication
(10) Pub. No.: US 2022/0062827 A1
(43) Pub. Date: Mar. 3, 2022

(54) CO-CASTING ULTRAFILTRATION MEMBRANES WITH DISORDERED BLOCK POLYMER SELECTIVE LAYERS

(71) Applicant: REGENTS OF THE UNIVERSITY OF MINNESOTA, Minneapolis, MN (US)

(72) Inventors: Marc Andrew Hillmyer, Minneapolis, MN (US); Nicholas Edward Hampu, Minneapolis, MN (US); Jay Werber, Minneapolis, MN (US)

(21) Appl. No.: 17/462,531

(22) Filed: Aug. 31, 2021

Related U.S. Application Data
(60) Provisional application No. 63/072,400, filed on Aug. 31, 2020.

(51) Int. Cl. B01D 67/00; B01D 71/80; B01D 71/68; B01D 61/14; B29C 41/22; B29C 41/08; B29C 41/42

(52) U.S. Cl. CPC B01D 67/0013; B01D 71/80; B01D 67/0018; B01D 67/0023; B01D 67/0088; B29L 2031/755; B01D 61/145; B29C 41/22; B29C 41/08; B29C 41/42; B01D 71/68

(57) ABSTRACT

Forming a dual layer filtration membrane includes disposing a first solution with a homopolymer and a first solvent on a substrate to yield a homopolymer layer on the substrate; disposing a second solution with a block polymer and a second solvent on the homopolymer layer to yield a dual layer liquid film having a block polymer layer on the homopolymer layer; disordering the block polymer layer to yield a disordered block polymer layer; vitrifying the disordered block polymer of the disordered block polymer layer and inducing phase separation and vitrification of the homopolymer of the homopolymer layer; and creating pores in the disordered block polymer layer to yield the dual layer filtration membrane having a porous disordered block polymer layer.

### CROSS-REFERENCE TO RELATED APPLICATION

This application claims the benefit of U.S. Patent Application No. 63/072,400 filed on Aug. 31, 2020, which is incorporated herein by reference in its entirety.

### TECHNICAL FIELD

This invention relates to co-casting ultrafiltration membranes with disordered block polymer selective layers.

### BACKGROUND

Commercial ultrafiltration membranes are typically prepared by non-solvent induced phase separation (NIPS), where a homopolymer solution is cast into a film and then immersed into a non-solvent coagulation bath to induce phase separation and pore formation. These membranes demonstrate excellent water permeability due to their plurality of continuous pores. However, the stochastic nature of NIPS can result in a broad pore size distribution, limiting their size-selectivity.

### SUMMARY

This disclosure describes a scalable membrane fabrication process that combines homopolymer non-solvent induced phase separation (NIPS) and disordered block polymer self-assembly to produce ultrafiltration membranes with high water permeability and high size-selectivity.

A highly selective and water permeable dual layer ultrafiltration membranes including a disordered block selective layer and a support layer are fabricated using a co-casting technique. A dilute solution of block polymer is spin coated onto a solvent-swollen support layer, rapidly heated to dry and disorder the block polymer layer, and subsequently immersed into an ice water coagulation bath to kinetically trap the disordered state in the block polymer selective layer and to precipitate the support layer by non-solvent induced phase separation. Subsequent removal of at least one block in the block polymer generates porous membranes suitable for ultrafiltration. The permeability of these dual layer membranes can be modulated by tuning the concentration of the support layer casting solution, while the size-selectivity is maintained due at least in part to the narrow pore size distribution of the self-assembled block polymer selective layer. Elimination of the thermal annealing step promotes an increase in the water permeability without adversely impacting the size-selectivity, as the disordered nanostructure present in the concentrated casting solution is kinetically trapped upon rapid drying.

In a general aspect, forming a dual layer filtration membrane includes disposing a first solution with a homopolymer and a first solvent on a substrate to yield a homopolymer layer on the substrate; disposing a second solution with a block polymer and a second solvent on the homopolymer layer to yield a dual layer liquid film having a block polymer layer on the homopolymer layer; disordering the block polymer layer to yield a disordered block polymer layer; vitrifying the disordered block polymer of the disordered block polymer layer and inducing phase separation and vitrification of the homopolymer of the homopolymer layer; and creating pores in the disordered block polymer layer to yield the dual layer filtration membrane having a porous disordered block polymer layer.

Implementations of the general aspect include one or more of the following features.

A concentration (wt %) of the homopolymer in the first solution can exceed a concentration (wt %) of the block polymer in the second solution (e.g., by at least a factor of 10). In some cases, a volatility of the second solvent at room temperature exceeds a volatility of the first solvent at room temperature.

In some cases, disordering the block polymer layer includes heating the dual layer liquid film above the order-disorder temperature of the block polymer. In certain cases, disordering the block polymer layer includes rapidly drying the block polymer film. In still other cases, disordering the block polymer layer includes solvent vapor annealing, selective swelling of the block polymer, or both.

Reducing the temperature of the dual layer liquid film can include immersing the dual layer liquid film into a water bath having a temperature in a range of −0° C. to 30° C.

Creating pores in the disordered block polymer can include chemically degrading a component of the block copolymer. Chemically degrading the component of the block polymer can include contacting the dual layer membrane with an aqueous base. In some cases, creating pores in the disordered block polymer layer comprises dissolution or depolymerization of a component. In certain cases, creating pores in the disordered block polymer layer involves selectively swelling the component in a solvent. A size of the pores in the porous disordered block polymer layer can be substantially uniform.

Phase separation in the homopolymer layer can include thermally induced phase separation by cooling the dual layer membrane below an upper critical solution temperature.

Disposing the first solution, the second solution, or both can be achieved by spin coating, curtain coating, blade coating, fiber spinning, or spray coating. The second solution can be disposed on the homopolymer layer while the homopolymer is swollen in the first solvent.

In some cases block polymer includes: a polystyrene, a polymethacrylate, a polyvinylidene fluoride, a polyolefin, a polyacrylonitrile, or a polysulfone; and a polyether, a polycarbonate, a polyester, a polyvinylpyridine, or a polysiloxane. The homopolymer can include a polysulfone, a polyethersulfone, a polyacrylonitrile, a polyimide, a polyvinylidene fluoride, or a polyethylene.

In some cases, the first solvent includes (or is) dimethylformamide. In some cases, the second solvent includes (or is) tetrahydrofuran.

Vitrifying the disordered block polymer of the disordered block polymer layer and inducing phase separation and vitrification of the homopolymer of the homopolymer layer can occur simultaneously.

The details of one or more embodiments of the subject matter of this disclosure are set forth in the accompanying drawings and the description. Other features, aspects, and advantages of the subject matter will become apparent from the description, the drawings, and the claims.

### BRIEF DESCRIPTION OF DRAWINGS

FIG. 1 is a schematic illustration of a fabrication procedure for a dual layer membrane, with temperature used to access the disordered state.

FIG. 2A shows rejection curves of fluorescently labeled dextran standards of dual layer and polysulfone (PSF) support membranes cast from 18, 20, and 22 wt % solutions of PSF in dimethylformamide (DMF). FIG. 2B shows water permeability of dual layer and bare PSF support membranes cast from 18, 20, and 22 wt % PSF.

FIG. 3 is a schematic illustration of a fabrication procedure for a dual layer membrane, with solvent used to access the disordered state.

FIG. 4A shows water flux as a function of applied pressure difference. FIG. 4B shows rejection of fluorescently labeled dextran standards for thermally annealed and as-cast dual layer membranes fabricated on PSF supports cast from an 18 wt % solution in DMF.

FIG. 5 shows bar graphs comparing the relative contributions of the PSF support layer and the SML-48 selective layer to the overall dual layer membrane permeability for different PSF concentrations.

### DETAILED DESCRIPTION

This disclosure describes a membrane fabrication process that combines homopolymer non-solvent induced separation (NIPS) and disordered block polymer self-assembly to produce dual layer membranes with both high water permeability and high size-selectivity. The fabrication process includes disposing a first solution including a homopolymer and a first solvent on a substrate to yield a homopolymer layer on the substrate. While the homopolymer layer is still swollen in the solvent, a second solution including a block polymer and a second solvent is disposed on the homopolymer layer. Intermixing of the homopolymer layer and the block polymer layer is limited, such that a dual layer liquid film results, including a block polymer layer on the homopolymer layer. A concentration of the homopolymer in the first solution exceeds a concentration of the block polymer in the second solution, and a volatility of the second solution at room temperature exceeds a volatility of the first solution at room temperature.

A variety of different processing techniques can be used to obtain the desired disordered block polymer morphology, such as heating above the order-disorder transition temperature, rapidly drying the block polymer film from solution, solvent vapor annealing, and selective swelling of disordered or discontinuous morphologies. Pore formation in the block polymer layer can be achieved by chemically etching one of the blocks or by selectively swelling one of the blocks in a preferential solvent. Pore formation in the homopolymer layer can proceed by non-solvent induced phase separation by immersing the film in a non-solvent bath or by thermally induced phase separation (TIPS) by rapidly cooling the film below the upper critical solution temperature. As used herein, “upper critical solution temperature” depends on the polymer, the solvent, and interactions between the polymer and the solvent and refers to the temperature above which the polymer and solvent are miscible and below which the solution phase separates.

Simultaneous precipitation of the homopolymer and vitrification of the disordered block polymer yields a porous support layer and a kinetically trapped selective layer, respectively. This process can be executed using solution casting methods such as spin coating, curtain coating, fiber spinning, spray coating, and the like. This process is compatible with multiple block polymer and homopolymer chemistries, enabling membranes to be tailored for specific applications. The block polymer typically includes a high glass transition temperature (Tg) or a crystalline matrix block (e.g., polystyrenes, polymethacrylates, polysulfones, polyolefins, polyvinylidene fluoride, polyacrylonitrile) and a selectively etchable or swellable pore-forming block (e.g., polyethers, polycarbonates, polyesters, polyvinylpyridines, polysiloxanes). The support layer can be any homopolymer that is compatible with the solution casting and membrane operation conditions (e.g., polysulfone, polyethersulfone, polyacrylonitrile, polyimide, polyvinylidene fluoride, polyethylene).

A temperature of the film is reduced (e.g., by contacting or immersing the film into ice water) to kinetically trap the disordered state in the block polymer layer and precipitate the homopolymer layer by non-solvent induced phase separation (NIPS). The subsequent removal of one of the block polymer domains (e.g., with an aqueous base) generates a porous selective layer with the uniform pore sizes for high size-selectivity. The homopolymer support layer imparts a high water permeability and mechanical robustness for sustained membrane operation.

### Examples

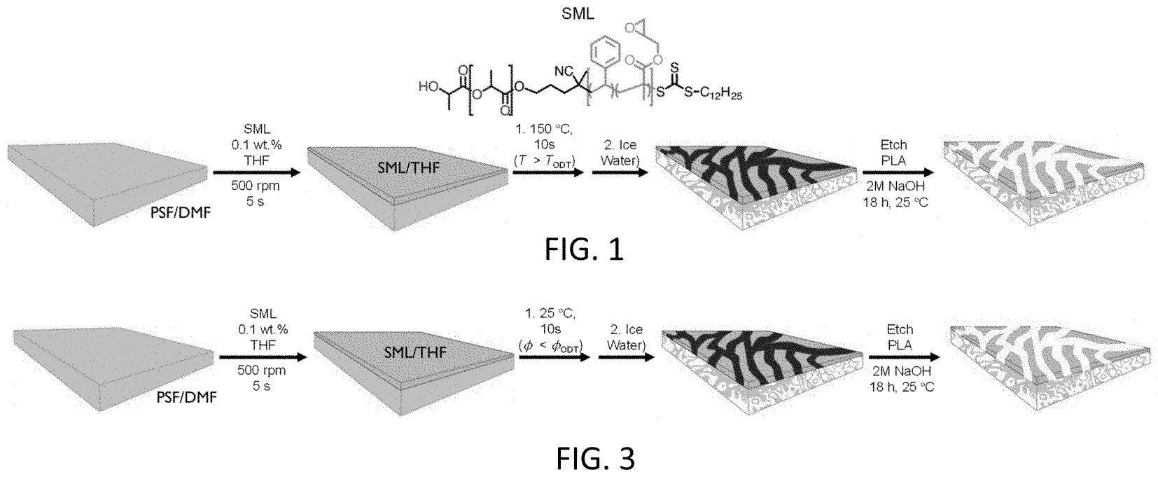

In one example, as depicted in FIG. 1, a concentrated solution of polysulfone (PSF) in dimethylformamide (DMF) (typically 18-22 wt % PSF) was spin coated onto a non-woven polyester backing at 500 rpm for 5 s. With the PSF layer still swollen in DMF, a layer of poly(methyl methacrylate-stat-styrene)-block-polylactide (SML) was spin coated from a 0.1 wt % solution in tetrahydrofuran (THF) on top of the PSF/DMF layer at 500 rpm for 5 s. The dual layer liquid film was annealed above the order-disorder transition temperature (Tour) at 150° C. for 10 s before immersing in an ice water coagulation bath to precipitate the PSF layer and trap the bicontinuous, fluctuating disordered state in the SML selective layer. The polylactic acid (PLA) domains were then selectively removed using aqueous base to generate a porous selective layer.

The SML block polymer used as the selective layer was synthesized by a reversible addition-fragmentation chain-transfer (RAFT) polymerization of methyl methacrylate (MMA) and styrene (S) from a PLA macro chain transfer agent. This diblock polymer has a number-average molar mass of the PLA block (M_{n, PLA}) of 19 kg mol⁻¹, a number-average molar mass of the P(MMA-s-S) block (M_{n, P(MMA-s-S)}) of 29 kg mol⁻¹, and a molar fraction of styrene in the P(MMA-s-S) block (XS) of 0.29, as determined by size-exclusion chromatography (SEC) and ¹H nuclear magnetic resonance (NMR) end group analysis. This diblock is referred to as SML-48. Dynamic mechanical analysis (DMA) and variable temperature small angle X-ray scattering (SAXS) for SML-48 demonstrate evidence of microphase segregation, yet the absence of higher order SAXS peaks and the lack of a clear rheological transition indicated a lack of long-range order.

To demonstrate production of porous materials from this diblock, a monolithic sample was annealed in the disordered state at 150° C. and rapidly quenched in liquid nitrogen to kinetically trap disordered state composition fluctuations. Following quenching, the PLA domains were selectively removed by immersing the monolith in a 2 M solution of NaOH in H₂O/MeOH (40/60 v/v) overnight at room temperature. Room temperature SAXS of the etched monolith displayed an increase in the scattered intensity as compared to the unetched precursor, while the scattering vector of the principal scattering peak, q*, remained unchanged. Additionally, a reticulated disordered morphology similar to other disordered and co-continuous polymers was observed by scanning electron microscopy (SEM) after etching. These results indicated that a porous material templated by the block polymer structure was obtained with minimal pore collapse. The three-dimensional continuity of these pores was confirmed by N2 sorption analysis, which revealed a Brunauer-Emmett-Teller (BET) surface area of 83 m² g⁻¹ and a monomodal pore size distribution with a mode of 14 nm using quenched solid density functional theory (QSDFT) pore size analysis. These results demonstrate that continuous pores with a narrow size distribution can be obtained from bulk samples, confirming the utility of SML-48 for membrane applications.

PSF was identified as a suitable homopolymer for the support layer. The high thermal and hydrolytic stability of PSF was compatible with the thermal annealing, solvents, and etching conditions used for the SML-48 selective layer. In contrast, other polymers commonly used in NIPS membranes (e.g., polyacrylonitrile) were observed to undergo hydrolysis and a subsequent loss of dimensional stability upon exposure to the alkaline PLA-etching solution. Dual layer membrane fabrication began with spin coating a concentrated PSF solution in DMF onto a 6 cm by 6 cm non-woven polyester backing that was pre-wet with DMF and taped to a 7.5 cm by 7.5 cm glass plate to ensure uniform spreading of the casting solution. Liquid discharge was observed along the walls of the spin coater, indicating that film spreading occurred by viscous flow (i.e., “spin off”) despite the relatively high solution viscosity and slow spin speed. Next, a dilute solution of SML-48 in tetrahydrofuran (THF) was filtered and deposited dropwise onto the static PSF/DMF layer, followed by spin coating. The dual layer liquid film was then annealed for a predetermined time at 150° C. to disorder the SML-48 layer and evaporate residual THF (normal boiling point of 66° C.), while the PSF layer remained swollen in the much less volatile DMF (normal boiling point of 150° C.). After annealing, the film was immersed in ice water to trap the disordered state in the SML selective layer and precipitate the PSF layer by NIPS.

To identify the effect that the support layer microstructure had on the dual layer membrane permeability and selectivity, the concentration of the PSF solution was varied while the coating parameters and annealing conditions for the selective layer were fixed. The concentration of the SML-48 solution was maintained at 0.1 wt % in THF. The annealing temperature and time for all membranes was 150° C. and 10 s, as higher temperatures and longer annealing times led to the formation of defective or dense membranes. A spin coating rate of 500 rpm for 5 s with a ramp rate of 500 rpm s⁻¹ was selected for casting both layers, as much faster rates or much longer times can result in undesirable DMF “spin off” from the support layer, leading to the formation of thin films with insufficient mechanical robustness for pressure-driven membrane operations. The concentration of the PSF solution was varied between 18 and 22 wt % in DMF. Lower concentrations of PSF (≤16 wt %) generally resulted in thin and highly defective membranes, while higher concentrations (≥25 wt %) resulted in dense and water impermeable membranes. Visually, the dual layer membranes appeared white and macroscopically uniform following immersion in the ice water bath, generally resembling commercial membranes prepared by NIPS.

Following fabrication, the PLA domains in the selective layer were selectively removed to generate a porous structure. For comparison, analogous bare PSF membranes were prepared using an identical procedure, except that PLA homopolymer with a number-average molar mass of 19 kg mol⁻¹ (referred to as PLA-19) was used as the second layer instead of SML-48. Subsequent etching of the PLA-19 homopolymer produced a PSF membrane that was expected to approximate the morphology of the underlying support layer in the dual membrane containing block polymer. The surface morphologies of the porous membranes were then examined using SEM. The dual layer membranes exhibited a noticeably different surface morphology than their corresponding support layers, consistent with a selective layer being successfully deposited onto the PSF surface. The pore size of the PSF support layer was observed to significantly increase with decreasing PSF concentration. In contrast, the pore size of the block polymer selective layer was relatively unaffected by the concentration of the PSF casting solution.

Cross-sectional SEM images of cryo-fractured membranes confirmed the existence of a dual layer film, comprising a thin and dense SML selective layer on top of a thicker and more porous PSF support layer. The thickness of the block polymer selective layer was approximately 800-1000 nm based on cross-sectional SEM, regardless of the PSF concentration. Based on the membrane area and the volume of the block polymer solution deposited during spin coating, a slightly thinner film (300 nm, neglecting any polymer mass lost during “spin off”) was expected. The larger film thickness measured by SEM may reflect deformation of the thin block polymer selective layer during sample preparation or incomplete spreading of the SML/THF solution during spin coating, resulting in an overestimate of the experimentally measured thickness.

Clear evidence of two layers in the cross-sectional SEM images along with the observed differences in surface morphology between the dual layer and the bare PSF membranes suggested that the SML selective layer did not delaminate from the PSF support. The dual layer membranes include a solid block polymer film on top of a DMF-swollen PSF support prior to immersion in the water bath, resulting in a large contact area between the layers that presumably promotes adhesion. Additionally, the thermal annealing process and the miscibility of the DMF used to cast PSF with the THF used to cast SML-48 may promote a small amount of interdiffusion of the SML-48 selective layer into the PSF support layer at the interface. In comparison, the hybrid SNIPS/NIPS approach comprises highly porous surfaces on both sides of the selective-layer/support-layer interface, which minimizes the overall contact area.

Due to its uniformly sized pores, the self-assembled block polymer selective layer was expected to result in a superior size-selectivity as compared to the bare PSF support fabricated using NIPS. To demonstrate this feature, each membrane was subjected to a series of feed solutions containing fluorescently labeled dextran standards of varying hydrodynamic radii. Rejection was determined based on the ratio of the maximum absorbance for the permeate solution to the feed solution using ultraviolet-visible (UV-Vis) spectroscopy.

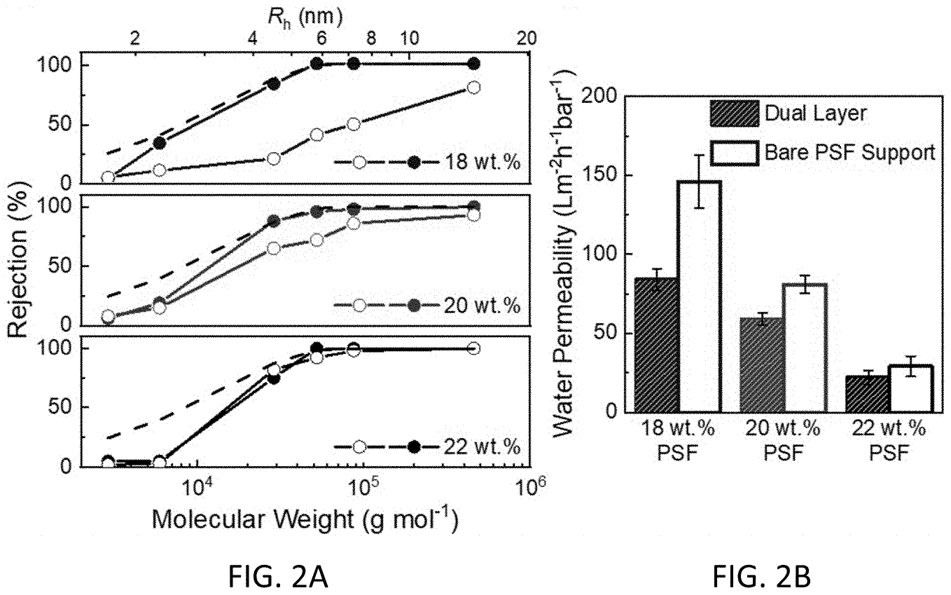

The rejection profiles for the dual layer membranes and their corresponding bare PSF supports are presented in FIG. 2A for membranes cast from 18, 20, and 22 wt % solutions of PSF in DMF. Rejection curves of fluorescently labeled dextran standards of dual layer and PSF support membranes cast from 18 (upper panel), 20 (middle panel), and 22 wt % (lower panel) solutions of PSF in DMF. Closed circles correspond to dual layer membranes with an SML-48 selective layer, and open circles correspond to bare PSF support membranes.

The experimentally measured rejection values were corrected using the mass transfer coefficient to account for concentration polarization to give true rejection values. The high stirring speed (300 rpm) and low applied pressure (0.5 bar) used during the filtration experiments minimized these concentration polarization effects. For membranes cast from 18 and 20 wt % PSF in DMF, the rejection of high dextran molar masses (large hydrodynamic radii, Rh) was significantly higher for the dual layer membranes than for the bare supports. These results were consistent with the conclusion that the block polymer selective layer had a smaller average pore size that could more completely reject larger molecules. Furthermore, the rejection profile was sharper for the dual layer membranes due at least in part to the narrow pore size distribution of the self-assembled block polymer in comparison to the NIPS support. The Rh that corresponds to the molecular weight cut-off (MWCO, defined as the molar mass where rejection is 90%) of the dual layer membranes was ˜5 nm, which was reasonably consistent with the mean pore radius of ˜6.8 nm determined by QSDFT for bulk monoliths of SML-48 subjected to identical thermal processing. The experimental data closely followed the theoretical prediction for the size-dependent rejection of solutes of radius, a, for an isoporous membrane with an average pore radius, rₚ, of 6.8 nm.

$$R = 1 - [ 2 {( 1 - \frac{a}{{r}_{p}} )}^{2} - {( 1 - \frac{a}{{r}_{p}} )}^{4} ] exp [ - 0.7146 {( \frac{a}{{r}_{p}} )}^{2} ] \qquad ( 1 )$$

Membranes cast from a 22 wt % solution of PSF in DMF exhibited only slight differences in dextran rejection between the dual layer and bare PSF membranes (FIG. 2A). A high rejection of dextran was observed in both cases. This high concentration of PSF likely resulted in a dense support layer with a comparable average pore size as SML-48, as evidenced by their similar MWCO. Overall, these results demonstrate that the uniform self-assembled block polymer domains improve upon the size-selectivity of the bare support layer fabricated using a modified NIPS process.

A limitation of NIPS membranes is that they can exhibit a significant trade-off between water permeability and size-selectivity due to their broad pore size distribution. The presence of a small population of large pores in the active layer can enable the permeation of some solute particles that are larger than the average pore size. Therefore, the average pore size of a NIPS membrane is typically smaller than the hydrodynamic radius of the solute targeted for rejection to ensure complete removal. However, water permeability scales as rₚ⁴ for a fixed pore number density, so even modest decreases in the average pore size can result in large decreases in the permeability. Consequently, NIPS membranes with smaller pore sizes typically enhance the solute rejection at the cost of decreased water permeability. In contrast, the uniform pores of a block polymer selective layer should attenuate this trade-off, as a larger average pore size for an isoporous membrane can achieve an identical solute rejection as a NIPS membrane with much smaller pores. For the dual layer membranes described herein, a sufficiently thin block polymer selective layer imparts a high size-selectivity without imposing a significant barrier to water transport.

The water permeability of the dual layer membrane is governed at least in part by the NIPS support without significantly altering the size-selectivity. FIG. 2B shows water permeability of dual layers (filled bars) and bare PSF support membranes (open bars) cast from 18 (left), 20 (middle), and 22 (right) wt % PSF. The permeability was determined based on the mean of three separate experiments, and the error bars correspond to the standard deviation. In particular, the water permeability of the dual layer membranes was shown to decrease from 84±7 to 59±4 to 22±5 L m⁻² h⁻¹ bar⁻¹ as the concentration of the PSF casting solution increased from 18 to 20 to 22 wt % in DMF. The water permeability was noticeably lower prior to PLA removal, suggesting that the selective layer pores primarily resulted from removal of the self-assembled PLA domains rather than by NIPS. Analogous measurements for the bare PSF supports displayed a qualitatively similar trend, decreasing from 146±17 to 81±6 to 29±7 L m⁻² h⁻¹ bar⁻¹ as the concentration of the PSF casting solution was increased from 18 to 20 to 22 wt % in DMF. Furthermore, SEM images of the bare PSF membranes displayed larger surface pores and more porous substructures for lower concentrations of PSF. These results suggest that the water permeability of the dual layer membranes is dependent upon the microstructure and the permeability of the PSF support. The presence of a highly concentrated (and potentially solvent-free) block polymer film may affect the diffusion of non-solvent into the support layer during NIPS, altering the precipitation pathway. This may result in selective layer pores that are not completely aligned with those in the support layer, unlike in conventional NIPS. However, since the disordered morphology of the selective layer is isotropic and co-continuous, misaligned pores are expected to increase the effective path length (tortuosity) for water transport rather than completely block the porous channels.

Despite the dependence of the water permeability on the PSF concentration, the size-selectivity and MWCO of the dual layer membranes remained essentially constant due to the nearly uniform pore size in the self-assembled SML-48 selective layer. In contrast, variations in casting solution concentration for the bare PSF membranes resulted in a trade-off between the water permeability and the size-selectivity. These results confirmed that the rejection profile of the dual layer membranes was governed at least in part by the uniform pores in the selective layer, while the water permeability was primarily governed by the support layer. This introduces the possibility of increasing the water permeability without compromising the selectivity, helping to minimize the large permeability-selectivity trade-off typically found in NIPS membranes.

The selection of quench temperatures above T_{ODT} resulted in segregation strengths, χN, that were lower than the critical value of approximately 10.5. However, χN can be reduced under isothermal conditions by swelling a block polymer in a neutral solvent. This screens the unfavorable enthalpic interactions between the two blocks at the domain interface and effectively lowers the T_{ODT}. This was demonstrated for bulk samples by hermetically sealing homogeneous mixtures of SML-48 and THF in differential scanning calorimeter (DSC) pans, and analyzing the mixtures using SAXS to monitor the development of the structure factor, S(q), as a function of polymer concentration. For very low concentrations (ϕ_{polymer}<0.4), featureless scattering patterns were observed, indicative of an unstructured system at these low values of χN. As the concentration increased (ϕ_{polymer}≥0.4), a broad peak in the SAXS patterns was observed that became increasingly sharp with increasing concentration, characteristic of more strongly segregated domains. These results are consistent with an increase in χN with increasing polymer concentration, and suggest that solvent can serve a similar function as temperature in modulating the segregation strength of SML-48. Reasonably similar scattering patterns were observed for SML-48 heated to a temperature above Tour in the melt state (T=150° C. and ϕ_{polymer}=1.0) and for SML-48 diluted below the ϕ_{ODT} in the solution state (T=25° C. and ϕ_{polymer}=0.7).

A disordered and bicontinuous morphology is understood to be kinetically trapped in the selective layer at ambient temperature by rapidly drying a block polymer solution into a solid film during the spin coating process. As the volatile THF solvent evaporates, the segregation strength of the block polymer selective layer will increase due to the increasing volume fraction of polymer. Eventually, at high block polymer concentrations, the system will solidify into a film, effectively vitrifying the morphology. If the drying process is sufficiently fast relative to the dynamics of the polymer chains, then the block polymer may be unable to order into its thermodynamically favored morphology prior to vitrification. Instead, it can be kinetically trapped in a disordered state that is expected to resemble the morphology that was observed after rapidly quenching from T>T_{ODT}.

To demonstrate this experimentally, the membrane fabrication procedure shown in FIG. 1 by eliminating the thermal annealing step. Instead, as depicted in FIG. 3, the dual layer liquid film was equilibrated for approximately 10 s at room temperature following block polymer casting before it was immersed into an ice water coagulation bath and then selectively etched. These membranes are referred to as “as-cast” membranes, while the thermally annealed membranes prepared using the process described with respect to FIG. 1 are referred to as “annealed” membranes.

As-cast membranes were prepared using a 0.1 wt % solution of SML-48 in THF as the selective layer casting solution and an 18 wt % solution of PSF in DMF as the support layer casting solution, as these concentrations resulted in the highest water permeability for the annealed membranes. Top view SEM images of the annealed and as-cast membranes revealed similar surface morphologies for the block polymer selective layers regardless of their processing history, while cross-sectional SEM images displayed reasonably similar selective layer thicknesses on the order of ˜800-1000 nm. These thicknesses likely overestimate the actual selective layer thickness, as the volume of deposited SML solution corresponds to a thickness of 300 nm (assuming uniform spreading of the entire solution volume across the 6 cm by 6 cm substrate). The actual thickness is likely even lower than 300 nm due to mass loss expected during spin coating. These results suggested that the disordered morphology trapped in the as-cast membranes generally resembled the fluctuating disordered morphology obtained in the annealed membranes, supporting the conclusion that solvent can be used as an alternative to temperature for tuning the segregation strength.

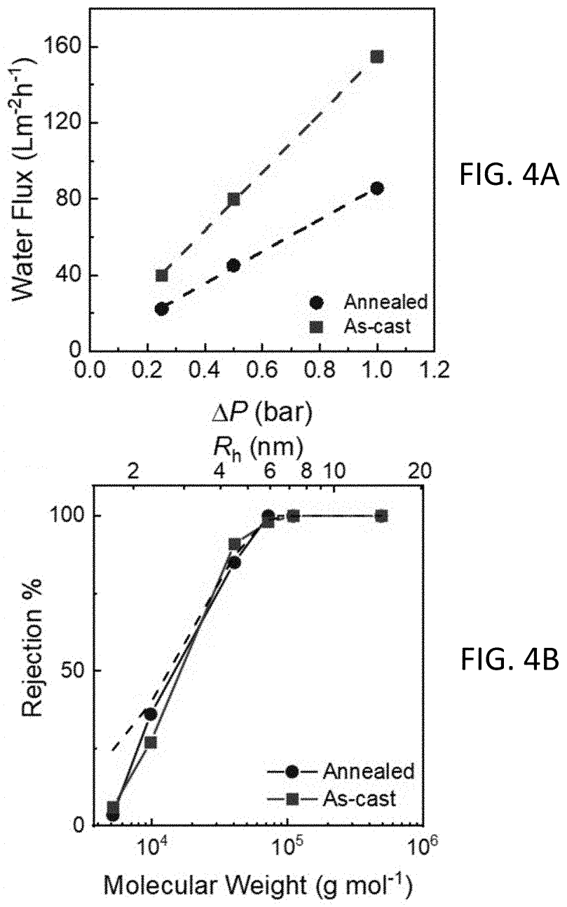

As shown in FIG. 4A, effectiveness of the solvent approach was confirmed by the sharp rejection curves with nearly identical MWCO observed for both the as-cast and annealed membranes, indicating that the block polymer selective layers had nearly uniform pores of similar size regardless of the thermal processing history. Despite their nearly identical rejection profiles, the water permeability of the as-cast membrane, 153±8 L m⁻² h⁻¹ bar⁻¹, was nearly twice that of the annealed membrane, 84±7 L m⁻² h⁻¹ bar⁻¹, as shown in FIG. 4B. Similar trends were observed for as-cast and annealed membranes with support layers cast from 20 and 22 wt % PSF solutions in DMF. Overall, these results confirmed that the dual layer membrane strategy outlined here allows for an increase in water permeability without compromising the size-selectivity.

The increased permeability for the as-cast membrane suggested that the thermal annealing process affected the phase behavior of the PSF layer, altering its precipitation pathway during NIPS and ultimately resulting in a less porous and less permeable substructure without significantly increasing the pore continuity of the block polymer selective layer. This was supported by a lower water permeability for the annealed bare PSF support (18 wt % in DMF), 146±17 L m⁻² h⁻¹ bar⁻¹, as compared to the analogous as-cast bare PSF support, 326±12 L mm⁻² h⁻¹ bar⁻¹. This decrease in the permeability of the PSF support upon thermal annealing resulted in a subsequent decrease in the permeability of the dual layer membrane, again suggesting that the PSF support layer primarily dictates the permeability of these dual layer membranes.

To better decouple the relative contributions of the support and selective layers to the dual layer membrane permeability, the dual layer membranes were modeled as resistors in series. This model assumes that the resistance to water flow for each layer is inversely proportional to the water permeability (P) of each layer. Consequently, the water permeability of the dual layer membrane follows the relationship:

P_{dual}⁻¹=Pₛᵤₚₚₒᵣₜ⁻¹+P_{selective}⁻¹ (2)

While the intrinsic permeability of the selective layer, P_{selective}, is difficult to measure directly, it can be readily extracted using Equation 2, provided that P_{dual} and Pₛᵤₚₚₒᵣₜ are experimentally known. Using this approach, the effect that thermal annealing had on the water permeability for both the support and the selective layers was examined independently.

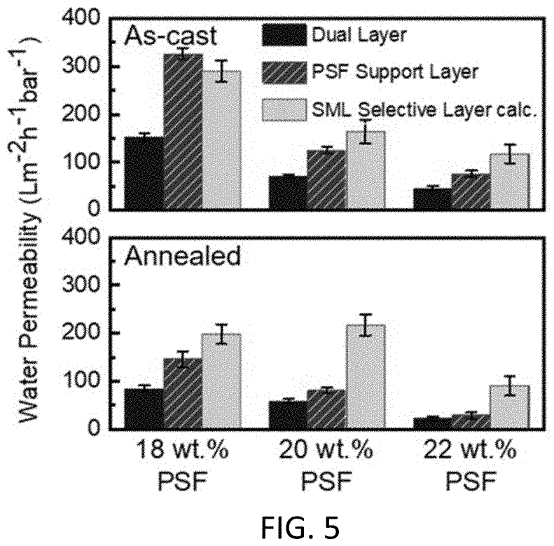

The experimentally measured values for P_{dual} and Pₛᵤₚₚₒᵣₜ along with the values of P_{selective} calculated using the model described in Equation 2 are provided in FIG. 5 for both annealed and as-cast membranes. Data for thermally annealed membranes is presented in the lower panel and data for the as-cast membranes is presented in the upper panel. The dual layer and PSF support layer permeabilities were measured experimentally. The selective layer permeability was calculated using the resistors in series model described in Equation 2. The permeability was determined based on the mean of three separate experiments, and the error bars correspond to the standard deviation.

Both the concentration of the PSF casting solution and the thermal processing method had a strong effect on the water permeability of the dual layer membranes (shown as an average of three separate experiments), ranging from 22±5 L m⁻² h⁻¹ bar⁻¹ for the annealed membrane prepared using a 22 wt % PSF solution to 153±8 L m⁻² h⁻¹ bar⁻¹ for the as-cast membrane prepared using an 18 wt % PSF solution. The calculated P_{selective} ranged from 91 to 290 L m⁻² h⁻¹ bar⁻¹ for all conditions examined here, exhibiting a weaker dependence on the selected processing parameters than Pₛᵤₚₚₒᵣₜ (i.e., a factor of 3 difference as compared to a factor of 7 difference for the dual layer membranes). The calculated selective layer permeabilities were approximately a factor of 3 lower the theoretical value of 730 L m⁻² h⁻¹ bar⁻¹ estimated using the Hagen-Poisseuille equation,

$$A = \frac{ɛ {r}_{p}^{2}}{8 {τ}^{2} μ {δ}_{m}} \qquad ( 3 )$$

assuming a porosity (ε) of 0.4 (volume fraction of PLA in SML-48), a tortuosity (τ) of 1.5, a pore radius (rₚ) of 6.8 nm, and a film thickness (l) of 300 nm (expected film thickness based on the volume of block polymer solution that was deposited during spin coating). The lower experimental permeabilities may reflect that the block polymer selective layer contains some amount of discontinuous pores (e.g., at the selective-layer/support-layer interface) or a higher than expected pore tortuosity.

An as-cast dual layer membrane was fabricated from a 0.05 wt % solution of SML-48 in THF and a 15 wt % solution of PSF in DMF. This membrane displayed a high water permeability of ˜250 L m⁻² h⁻¹ bar⁻¹ due to its thinner selective layer and more porous support layer. Additionally, a nearly identical rejection profile to the membranes cast from 0.1 wt % solutions of SML-48 was obtained.

### Materials

Unless specifically noted, all chemicals were purchased from Sigma-Aldrich. 1,8-dizabicycloundec-7-ene (DBU) was used without further purification. Azobisisobutyronitrile (AIBN) (98%) was recrystallized from methanol and dried under reduced pressure overnight. 4-cyano-4-[(dodecylsulfanylthiocarbonyl) sulfanyl]pentanol was dried under reduced pressure overnight prior to use. Styrene (S) (≥99%, stabilized) and methyl methacrylate (MMA) (99%, stabilized) were passed through a basic alumina column prior to use. ±-lactide (99%) from Altasorb, recrystallized from toluene, and stored under a N₂ atmosphere. All bulk solvents were purchased from Fisher Scientific and used as received unless otherwise specified. Dichloromethane (DCM) was purified using a solvent system comprised of columns of activated alumina and molecular sieves. Polysulfone (PSF), Udel P1700, was obtained from Solvay. Hollytex 3265, a non-woven polyester, was used as a support for the PSF membrane and was kindly provided by Ahlstrom-Munksjo. Blue dextran standards were obtained from TdB Consultancy.

### Methods

NMR. ¹H NMR spectroscopy experiments were performed on a Bruker Avance III HD nanobay AX-400 spectrometer equipped with a 5 mm BBO SmartProbe and a SampleXpress autosampler. Spectra of the polymers were acquired in CDCl₃ using tetramethylsilane as a reference.

SEC. SEC analysis was performed in tetrahydrofuran at 25° C. using an Agilent 1260 Infinity liquid chromatograph system equipped with three Waters Styragel columns in series, as well as a Wyatt DAWN Heleos II 18-angle laser light scattering detector S4 and a Wyatt OPTILAB T-rEX refractive index detector.

Dynamic Mechanical Analysis. The rheological response of the block polymers was evaluated on a Rheometrics ARES mechanical spectrometer equipped with an 8 mm parallel plate geometry. The oven was maintained under nitrogen atmosphere to prevent thermal degradation of the sample. Samples were annealed overnight at 100° C. under reduced pressure prior to data acquisition. Circular discs were molded to the parallel plate geometry in-situ under compression at 95° C. The order-disorder transition temperature (T_{ODT}) of the block polymer was determined from a dynamic temperature sweep in the linear viscoelastic regime from 95° C. acquired using a heating rate of 2° C. min′ with an angular frequency ω=1 rad s⁻¹ and a shear strain ε=1%. A change in the slope of G′ indicates the transition of the ordered microstructure to a disordered state. A frequency sweep was performed at 95° C. (above T_{g} but below T_{ODT}) with a shear strain of 1% for frequencies from 0.01 to 100 rad s⁻¹, and the frequency dependence of G′ was extracted by fitting a power law to the low frequency data (typically 0.01 to 0.1 rad s⁻¹), G′˜ωⁿ.

SAXS. SAXS profiles were collected at the Advanced Photon Source (APS) at Argonne National Laboratories using the Sector 5-ID-D beamline, which is maintained by the DuPont-Northwestern-Dow Collaborative Access Team. Scattering experiments were performed using X-rays of wavelength 0.76 Å and the scattering intensity was collected on a 2D Mar charge-coupled device (CCD) detector. Sample-to-detector distances were calibrated using a silver behenate standard. Intensity as a function of the wave vector, q, where q=(4π/λ) sin(θ/2) (θ is the scattering angle and λ is the X-ray wavelength), was obtained by azimuthally integrating the 2D patterns. For the quenched samples, SAXS profiles were collected at room temperature by directly using a monolith of the materials. For the measurement of the T_{ODT}, the sample was loaded into a quartz capillary and annealed overnight under reduced pressure at 100° C. The capillary was mounted in a Linkam heating stage for variable temperature measurements. The sample was equilibrated for at least 2 min at each temperature prior to data collection.

Gas sorption. The nitrogen adsorption isotherm was obtained on a Quantachrome Autosorb iQ (Boynton Beach, Fla.) at the temperature of liquid nitrogen (77.3 K). The sample was loaded in 6 mm stems and degassed for 20 h at room temperature before measurement using a turbomolecular pump. The BET specific surface area was obtained from the adsorption branch from P/P₀=0.05-0.35. The mesopore size distribution was estimated using a quenched solid density functional theory (QSDFT) kernel for the adsorption branch of nitrogen on carbon using a cylindrical pore model.

SEM. Membrane samples were fractured in liquid nitrogen to ensure clean fractures for cross-sectional imaging. SEM micrographs were obtained on a Hitachi SU8230 cold FEG-SEM with an accelerating voltage of 3 kV, an upper secondary electron detector, and a lateral resolution of 1.1 nm at a working distance of 5 mm. Before imaging, samples were coated with approximately 2 nm of Ir via sputtering using an ACE600 coater.

Water Flux Measurements. A 2.5 cm diameter disc of the etched UF membrane was loaded into an Amicon 8010 stirred cell. The cell was pressurized using N2 gas to induce water flow through the membrane. The permeate was collected in a glass vessel placed on top of a mass balance that was interfaced to a computer. Water flux was measured based on the change in the mass of permeated water over the experimental time scale. Three different pressure differences were applied to the cell (0.25, 0.5, and 1 bar) to determine the relationship between applied pressure and water flux. Water permeability was calculated based on the slope of a linear fit to the water flux vs. applied pressure data.

Dextran Rejection Experiments. Size rejection experiments were performed using fluorescently labelled dextran standards (blue dextran) of varying molar masses (4, 10, 40, 70, 110, and 400 kg mol⁻¹). Each blue dextran standard was dissolved in deionized water to a concentration of 0.5 mg cm⁻³ to form separate solutions. The solution was then added to the dry Amicon 8010 stirred cell containing the dual layer membrane, stirred at 500 rpm, and pressurized to 0.5 bar. The permeate was collected in a clean glass vial. Rejection was determined using UV-Vis spectroscopy based on the ratio of the absorbance of the permeate solution to the absorbance of the feed solution at the wavelength corresponding to maximum absorbance. This experimental protocol was repeated for every dextran molar mass to generate a rejection curve.

### Block Polymer Synthesis

PLA-CTA synthesis ±-lactide (7.0 g, 118 molar eq.) and DCM (50 mL) were mixed in a 100 mL pressure vessel in a N2 filled glovebox. In a separate vial, 4-cyano-4-[(dodecylsulfanylthiocarbonyl) sulfanyl]pentanol (0.16 g, 1 mol. eq.) was dissolved in DCM (5 mL). After the ±-lactide was completely dissolved, the chain transfer agent (CTA) solution was added to the pressure vessel and the mixture was stirred for several minutes. The catalyst 1,8-diazabicyclo [5.4.0]undec-7-ene (DBU) (0.06 mL, 1 mol. eq.) was then added to the solution, the pressure vessel was hermetically sealed, and the reaction was removed from the glovebox. The reaction mixture was stirred for 20 min at room temperature. The polymerization was then exposed to air and benzoic acid (0.13 g, 2.5 mol. eq.) was added to quench the reaction. The mixture was precipitated into excess methanol, filtered, and dried overnight at room temperature under reduced pressure.

The molar mass and molar mass dispersity, Ð, of PLA-19 was examined using SEC as described herein. The mass-average molar mass, M_{w}, was determined using the asymptotic value of dn/dc at high molar mass for PLA in THF at 25° C., dn/dc=0.049 mL g⁻¹, along with multi-angle light scattering detectors.

The number average molar mass of PLA, M_{n, PLA}, was determined by end group analysis with ¹H NMR using CDCl₃ as the solvent. The methine protons from the PLA backbone (1H per repeat unit, 5.0-5.4 ppm) were integrated with respect to the methylene protons adjacent to the trithiocarbonate of the CTA (2H, 3.30-3.40 ppm).

P(MMA-s-S)-b-PLA synthesis The SML block polymer used as the selective layer was synthesized by a reversible addition-fragmentation chain-transfer (RAFT) polymerization of MMA and S from a PLA macro chain transfer agent. A diblock polymer with a number-average molar mass of the PLA block (M_{n, PLA}) of 19 kg mol⁻¹, a number-average molar mass of the P(MMA-s-S) block (M_{n, P(MMA-s-S)}) of 29 kg mol⁻¹, and a molar fraction of styrene in the P(MMA-s-S) block (XS) of 0.29, was used, as determined by SEC and ¹H NMR end group analysis.

PLA-19 (0.3 g, 1 eq.) was dissolved in styrene (S, 0.13 g, 80 eq.) and methyl methacrylate (MMA, 0.40 g, 254 eq.) monomers in a 2 dram vial equipped with a septum. Following complete dissolution, the free radical initiator azobisisobutyronitrile (AIBN) (0.65 mg, 0.25 eq., 33 μL as a 2 wt % solution in toluene) was added to the reaction mixture. The vial was then sealed and sparged with N2 for 20 min before immersing it into a pre-heated silicone oil bath set to 80° C. The polymerization was run for 5 h (approximately 40% conversion of MMA) and the reaction was terminated by exposure to air. The polymer was diluted in THF, precipitated into methanol, and dried overnight under reduced pressure at 100° C.

The molar mass and the molar mass dispersity were obtained using SEC with a THF mobile phase. The dn/dc value was estimated from the weight average of the reported literature value for PLA, PS, and PMMA in THF, according to the weight fraction of PLA and XS as determined by ¹H-NMR.

The composition of the diblock was analyzed using ¹H-NMR spectroscopy. The methyl protons of MMA were assigned to the peaks at 2.10-4.20 ppm (3H per repeating unit) and the aromatic protons of S were assigned to the peaks at 6.30-7.20 ppm (5H per repeating unit) according to the literature. The methine protons of PLA (5.00-5.40 ppm, 1H per repeating unit) were used to define a reference integral, I_{Ref}, as follows:

$${I}_{R e f} = {I}_{P L A} \times M ( L A ) / {M}_{n} ( P L A ) \qquad ( 4 )$$

where I_{PLA} is the integral of the methine protons, Mₙ(PLA) is the molecular weight of the PLA block calculated by NMR, and M(LA) is the molar mass of one repeating unit of PLA (72 g mol⁻¹).

The integrals of the methyl protons of PMMA and the aromatic protons of PS were used to calculate the molar mass of P(MMA-s-S) by end group analysis, M_{n, P(MMA-s-S)}.

$${M}_{n , P \begin{matrix} \\ \end{matrix} ( M M A - s - S )} = [ M ( S ) \times {I}_{S} ] / ( 5 \times {I}_{R e f} ) + [ M ( M M A ) \times {I}_{M M A} ] / ( 3 \times {I}_{R e f} ) \qquad ( 5 )$$

where M(S) and M(MMA) are the molar masses of styrene (104 g mol⁻¹) and MMA (100 g mol⁻¹), respectively. Additionally, the molar fraction of S in the P(MMA-s-S) block was calculated using the equation

$$XS = ( \frac{{I}_{s}}{5} ) / [ ( {I}_{M M A} / 3 ) + ( {I}_{S} / 5 ) ] \qquad ( 6 )$$

### Morphological Characterization of SML-48

Dynamic mechanical analysis Dynamic mechanical analysis was used to examine the frequency dependence of the storage modulus, G′, according to the method described herein. The polymer was annealed overnight at 100° C. under reduced pressure before testing. Approximately 0.1 g of polymer was molded using an 8 mm parallel plate geometry at 95° C. to fill a gap of approximately 1 mm. The frequency dependence of G′ at 95° C. was then examined by varying the frequency from 100 rad s⁻¹ to approximately 0.01 rad s⁻¹ at a constant strain of 1%. A power law fit was then applied to the low frequency data (G′˜ωⁿ, typically for ω<0.1 rad s⁻¹) and the power law exponent, n, was extracted.

The temperature dependence of G′ for the polymer was determined from a linear dynamic temperature ramp using a heating rate of 2° C. min⁻¹ with an angular frequency ω=1 rad s⁻¹ and a shear strain ε=1%. A change in the slope of G′ with temperature is indicative of an order-disorder transition temperature (T_{ODT}). For SML-48, a slight change in slope around 130° C. was observed, possibly suggesting an ODT. The change in viscoelastic properties was significantly less dramatic than is usually observed at an ODT, possibly do to the low χ of this block polymer. Complementary SAXS analysis demonstrates that this diblock is clearly disordered by 150° C.

Variable temperature SAXS The morphology and T_{ODT}'s of SML-48 was examined using variable temperature small angle X-ray scattering. The polymer was loaded into an aluminum DSC pan and annealed overnight under reduced pressure at 100° C. The sample was first exposed to X-rays at room temperature to identify the equilibrium room temperature morphology. The temperature was then increased to monitor the evolution of the morphology. The sample was annealed for at least 2 min at each temperature prior to collecting data to allow the morphology to equilibrate.

Room temperature SAXS of etched monoliths The morphology of a monolith of SML-48 after annealing for 1 h at 150° C. and immediately quenching in liquid nitrogen was examined using room temperature SAXS both before and after etching. To remove the PLA domains and generate a porous material, the polymer was immersed in a solution of aqueous base, 2 M NaOH (40/60 H₂O/MeOH v/v), overnight at room temperature and pressure. Then the sample was filtered, rinsed with methanol (MeOH) and water, and dried overnight under reduced pressure at room temperature. The unetched and etched samples were mounted on Kapton tape prior to SAXS data acquisition.

### Dual Layer Membrane Fabrication

General Procedure An approximately 6 cm by 6 cm square of a non-woven polyester support was cut from a larger sheet using scissors. This piece was then mounted on top of a 7.5 cm by 7.5 cm square glass plate and secured using electrical tape. Care was taken to ensure that the polyester support remained flat against the glass plate to prevent bubble and hole formation during membrane casting. The glass plate was then placed on top of a spin coater and secured by pulling vacuum. The polyester film was pre-wet with a small amount of DMF (approximately 0.1 mL) to promote spreading of the PSF solution across the support and to prevent defect formation. The PSF support layer solution (approximately 1 mL) was dropped onto the center of the static polyester film. The film was accelerated at a rate of 500 rpm s⁻¹ and spin coated at 500 rpm for 5 s using a Brewer Science Cee 200 spin coater. Immediately following the completion of the process, the block polymer selective layer solution was filtered through a 0.22 μm syringe and dropped in the center of the DMF-swollen PSF layer in a static dispense. The film was accelerated at a rate of 500 rpm s⁻¹ and spin coated at 500 rpm for 5 s. Following both coating steps, liquid was observed on the walls of the spin coater, suggesting that solvent was lost by viscous flow (i.e. “spin off”).

Following the completion of both spin coating steps, two liquid layers should be present: a denser and more viscous PSF layer swollen in DMF on the bottom and a less viscous P(MMA-s-S)-b-PLA layer swollen in THF on the top. Two different thermal processing methods were then examined to generate the final membrane. In the thermally annealed system, the film was moved to a covered and pre-heated hot plate set to 150° C. for 10 s to ensure complete THF removal and then immersed in an ice water coagulation bath to both precipitate the PSF support layer and vitrify the P(MMA-s-S)-b-PLA selective layer. In the as-cast system, the film sat for 10 s at room temperature before immersing in the ice water coagulation bath.

Following precipitation, all membranes remained in the water bath for at least 1 h prior to further experiments. For water flux and Dextran rejection experiments, a 2.5-cm diameter disc was cut from the center of the larger sheet. The membranes were then immersed in a 2 M NaOH solution in methanol/water (60/40 v/v) for 1 h to remove the PLA domains in the selective layer, generating pores.

Control membranes were made using an identical process except that a PLA homopolymer was used instead of the P(MMA-s-S)-b-PLA block polymer for the second layer. Selective removal of PLA then results in a bare PSF support.

Calculation of true rejection Experimental rejection values were calculated by comparing the concentration of a known solute in the permeate solution, cₚₑᵣₘ, to the concentration in the initial feed solution, c_{feed}:

$${R}_{a p p} = 1 - \frac{{c}_{p e r m}}{{c}_{f e e d}} \qquad ( 7 )$$

However, the rejection calculated according to Equation 7 represents an apparent rejection, Rₐₚₚ, rather than the true rejection. The true rejection, Rₜᵣᵤₑ, will actually be higher than Rₐₚₚ due to concentration polarization. Concentration polarization describes the development of a solute concentration gradient at the membrane-solution interface caused by convective transport of retained solute particles towards the feed-side of the membrane. This effectively increases the concentration of solute at the membrane surface so that the effective concentration is higher than the initially prepared feed solution used in the calculation of Equation 7. Concentration polarization is highly dependent on the water flux through the membrane, the solute rejection, and the stirring rate for dead-end filtration set-ups similar to the one used in the present work. Higher water fluxes, higher solute rejections, and slower stirring speeds tend to exacerbate concentration polarization.

The effect of concentration polarization on solute rejection can be accounted for by calculating Rₐₚₚ using Equation 7 and then correcting for the geometry of the filtration cell, the water flux, the mass transfer coefficient of the solute, and the stirring speed. Applying such a correction yields the true rejection, Rₜᵣᵤₑ, as calculated using the following equation:

$${R}_{t r u e} = \frac{1}{exp [ ln ( \frac{1 - {R}_{a p p}}{{R}_{a p p}} ) - \frac{J v}{k} ]} \qquad ( 8 )$$

where Jᵥ is the volumetric flux of water through the membrane and k is the mass transfer coefficient in the membrane boundary layer. The mass transfer coefficient can be estimated according to the infinite rejection model based on the stirring speed and the filtration cell geometry

k=aωⁿ (9)

where a and n are constants that depend on the filtration cell used in the rejection experiment and ω is the stirring rate. For the Amicon 8010 filtration cell, a and n are assumed to be 1.08×10⁻⁵ and 0.567, respectively. The stirring rate, ω, used for all rejection experiments was 400 rpm. An applied pressured difference of 0.5 bar was used for all filtration experiments, and the volumetric water flux, Jᵥ, for each membrane at that pressure difference was used in the calculation of Equation 8.

For the rejection experiments reported in the present work, the low applied pressure difference (low Jᵥ) and fast stirring rate minimized concentration polarization effects. Equations. 5 and 6 were applied to the dual layer membrane composed of an as-cast SML-48 selective layer and an 18 wt % PSF support layer, the most permeable membrane examined. Based on the volumetric water flux for this membrane at 0.5 bar, Rₜᵣᵤₑ was found to be at most 5% higher than Rₐₚₚ. Therefore, solute rejection is primarily driven by size-exclusion rather than concentration polarization for all the dual layer membranes examined in this work. Rejection values represent true rejection values calculated using Equation 8 to properly account for concentration polarization.

For solution SAXS experiments, solutions of SML-48 in THF were prepared and loaded into aluminum DSC pans. The pans were hermetically sealed immediately after loading to prevent solvent evaporation. Scattering experiments were performed at room temperature and data reduction was performed as described herein.

Although this disclosure contains many specific embodiment details, these should not be construed as limitations on the scope of the subject matter or on the scope of what may be claimed, but rather as descriptions of features that may be specific to particular embodiments. Certain features that are described in this disclosure in the context of separate embodiments can also be implemented, in combination, in a single embodiment. Conversely, various features that are described in the context of a single embodiment can also be implemented in multiple embodiments, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular embodiments of the subject matter have been described. Other embodiments, alterations, and permutations of the described embodiments are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results.

Accordingly, the previously described example embodiments do not define or constrain this disclosure. Other changes, substitutions, and alterations are also possible without departing from the spirit and scope of this disclosure.

What is claimed is:

1. A method of forming a dual layer filtration membrane, the method comprising:
disposing a first solution comprising a homopolymer and a first solvent on a substrate to yield a homopolymer layer on the substrate;
disposing a second solution comprising a block polymer and a second solvent on the homopolymer layer to yield a dual layer liquid film comprising a block polymer layer on the homopolymer layer;
disordering the block polymer layer to yield a disordered block polymer layer;
vitrifying the disordered block polymer of the disordered block polymer layer and inducing phase separation and vitrification of the homopolymer of the homopolymer layer; and
creating pores in the disordered block polymer layer to yield the dual layer filtration membrane comprising a porous disordered block polymer layer.

2. The method of claim 1, wherein a concentration (wt %) of the homopolymer in the first solution exceeds a concentration (wt %) of the block polymer in the second solution.

3. The method of claim 2, wherein a concentration (wt %) of the homopolymer in the first solution exceeds a concentration (wt %) of the block polymer in the second solution by at least a factor of ten.

4. The method of claim 1, wherein a volatility of the second solvent at room temperature exceeds a volatility of the first solvent at room temperature.

5. The method of claim 1, wherein disordering the block polymer layer comprises heating the dual layer liquid film above the order-disorder temperature of the block polymer.

6. The method of claim 1, wherein disordering the block polymer layer comprises rapidly drying the block polymer film.

7. The method of claim 1, wherein disordering the block polymer layer comprises solvent vapor annealing.

8. The method of claim 1, wherein disordering the block polymer layer comprises selective swelling of the block polymer.

9. The method of claim 1, wherein reducing the temperature of the dual layer liquid film comprises immersing the dual layer liquid film into a water bath having a temperature in a range of −0° C. to 30° C.

10. The method of claim 1, wherein creating pores in the disordered block polymer comprises chemically degrading a component of the block copolymer.

11. The method of claim 10, wherein chemically degrading the component of the block polymer comprises contacting the dual layer membrane with an aqueous base.

12. The method of claim 1, wherein creating pores in the disordered block polymer layer comprises dissolution or depolymerization of a component.

13. The method of claim 1, wherein creating pores in the disordered block polymer layer comprises selectively swelling the component in a solvent.

14. The method of claim 1, wherein phase separation in the homopolymer layer comprises thermally induced phase separation by cooling the dual layer membrane below an upper critical solution temperature.

15. The method of claim 1, wherein disposing the first solution, the second solution, or both comprises spin coating, curtain coating, blade coating, fiber spinning, or spray coating.

16. The method of claim 1, wherein the block polymer comprises:
a polystyrene, a polymethacrylate, a polyvinylidene fluoride, a polyolefin, a polyacrylonitrile, or a polysulfone; and
a polyether, a polycarbonate, a polyester, a polyvinylpyridine, or a polysiloxane.

17. The method of claim 1, wherein the homopolymer comprises a polysulfone, a polyethersulfone, a polyacrylonitrile, a polyimide, a polyvinylidene fluoride, or a polyethylene.

18. The method of claim 1, wherein a size of the pores in the porous disordered block polymer layer is substantially uniform.

19. The method of claim 1, comprising disposing the second solution on the homopolymer layer while the homopolymer is swollen in the first solvent.

20. The method of claim 1, wherein the first solvent comprises dimethylformamide.

21. The method of claim 1, wherein the second solvent comprises tetrahydrofuran.

22. The method of claim 1, wherein vitrifying the disordered block polymer of the disordered block polymer layer and inducing phase separation and vitrification of the homopolymer of the homopolymer layer occur simultaneously.
